(19) United States
(12) Patent Application Publication
(10) Pub. No.: US 2026/0036968 A1
(43) Pub. Date: Feb. 5, 2026

(54) DYNAMIC BLOCKCHAIN-BASED TRUSTWORTHY SCHEDULING METHOD AND DEVICE FOR INDUSTRIAL WIRELESS NETWORKS

(71) Applicant: Shenyang Institute of Automation, Chinese Academy of Sciences, Shenyang (CN)

(72) Inventors: Chi XU, Shenyang (CN); Peifeng ZHANG, Shenyang (CN); Haibin YU, Shenyang (CN); Dong LI, Shenyang (CN); Peng ZENG, Shenyang (CN)

(73) Assignee: Shenyang Institute of Automation, Chinese Academy of Sciences, Shenyang (CN)

(21) Appl. No.: 19/193,602

(22) Filed: Apr. 29, 2025

Related U.S. Application Data
(63) Continuation of application No. PCT/CN2025/079447, filed on Feb. 27, 2025.

(30) Foreign Application Priority Data
Aug. 2, 2024 (CN) 202411056375.X

(51) Int. Cl. G05B 19/418

(52) U.S. Cl. CPC G05B 19/41845; G05B 19/4185; G05B 2219/32335

(57) ABSTRACT

A dynamic blockchain-based trustworthy scheduling method and device for industrial wireless networks are provided. The method comprises: Construct an optimization model for scheduling the industrial wireless network with the goal of maximizing the trustworthy processing efficiency of tasks. performing model reconstruction on the optimization model based on a preset multi-agent Markov decision process model to obtain a target optimization model; and optimizing the target optimization model using a preset rotating multi-agent deep reinforcement learning algorithm model on the basis of observation information of industrial devices in the industrial wireless network collected in real time, to obtain target parameters corresponding to the parameters to be optimized for scheduling the industrial wireless network. The method of the present application improves the trustworthy processing efficiency of tasks in the industrial wireless network.

### CROSS-REFERENCE TO RELATED APPLICATIONS

The application claims priority to Chinese patent application No. 202411056375.X, filed on Aug. 2, 2024, the entire contents of which are incorporated herein by reference.

### TECHNICAL FIELD

The present application relates to transmission scheduling technology for industrial Internet of Things, and in particular to a dynamic blockchain-based trustworthy scheduling method and device for industrial wireless networks.

### BACKGROUND

Along with the rapid development of industrial Internet of Things, more and more industrial devices access Internet. Humans, machines and objects are connected to each other so that a highly intelligent industrial system is realized. However, running computation-intensive applications on devices with limited computing frequency and limited battery capacity may result in significant computing delay and excessive energy consumption, severely reducing users' quality of experience. In order to solve the problem, edge computing emerges, so that a task can be offloaded to edge servers to be processed in real time.

However, a large number of heterogeneous industrial devices accessing to the industrial wireless network has an influence on the trustworthiness between the industrial devices and the edge server in industrial Internet of Things, making information vulnerable to attackers. Therefore, the blockchain technology is introduced to enhance the security and privacy of industrial Internet of Things.

However, simply adding the blockchain to industrial wireless network may not ensure the trustworthiness between industrial devices and edge servers, and may even exacerbate overhead instead, resulting in failure of edge computing.

### SUMMARY

In view of the above, the application provides a dynamic blockchain-based trustworthy scheduling method and device for industrial wireless networks, to solve the problem of low trustworthiness between industrial devices and edge servers as well as the high failure rate of edge computing in the joint scheduling of tasks and resources in industrial wireless networks.

To solve the problem, the application provides a dynamic blockchain-based trustworthy scheduling method for industrial wireless networks, and the method comprises: constructing an industrial wireless network based on a dynamic blockchain mechanism; performing model construction on the basis of preset constraints respectively corresponding to a task and resource joint scheduling stage of the industrial wireless network and a consensus stage of the dynamic blockchain mechanism with maximizing task trustworthy processing efficiency as a target, to obtain an optimization model carrying parameters to be optimized for scheduling the industrial wireless network; performing model reconstruction on the optimization model based on a preset multi-agent Markov decision process model to obtain a target optimization model; and optimizing the target optimization model using a preset rotating multi-agent deep reinforcement learning algorithm model on the basis of observation information of industrial devices in the industrial wireless network collected in real time, to obtain target parameters corresponding to the parameters to be optimized for scheduling the industrial wireless network.

To solve the problem, the application provides a dynamic blockchain-based trustworthy scheduling device for an industrial wireless network, and the device comprises: an industrial wireless network construction module configured to construct an industrial wireless network based on a dynamic blockchain mechanism; a model construction module configured to perform model construction on the basis of preset constraints respectively corresponding to a task and resource joint scheduling stage of the industrial wireless network and a consensus stage of the dynamic blockchain mechanism with maximizing task trustworthy processing efficiency as a target, to obtain an optimization model for scheduling the industrial wireless network, the optimization model carrying parameters to be optimized; a model reconstruction module configured to perform model reconstruction on the optimization model based on a preset multi-agent Markov decision process model to obtain a target optimization model; and an optimization module configured to optimize the target optimization model using a preset rotating multi-agent deep reinforcement learning algorithm model on the basis of observation information of industrial devices in the industrial wireless network collected in real time, to obtain target parameters corresponding to the parameters to be optimized for scheduling the industrial wireless network.

In order to solve the problem, the application provides a storage medium, the storage medium stores a computer program, and when the computer program is executed by a processor, the steps of the dynamic blockchain-based trustworthy scheduling method for an industrial wireless network are performed.

In order to solve the problem, the application provides an electronic device which at least comprises a memory and a processor, a computer program is stored on the memory, and the processor, when executing the computer program on the memory, performs the dynamic blockchain-based trustworthy scheduling method for an industrial wireless network.

This application has the following beneficial effects. This application constructs an industrial wireless network based on a dynamic blockchain mechanism. Based on the preset constraints corresponding to the task and resource joint scheduling stage of the industrial wireless network and the consensus stage of the dynamic blockchain mechanism, a model is constructed with the goal of maximizing the task trustworthy processing efficiency, and an optimization model carrying various parameters to be optimized for scheduling the industrial wireless network is obtained. The dynamic blockchain mechanism is adopted to dynamically adjust the leader edge server and the blockchain waiting time window according to the network status and task requirements, which not only ensures security and trustworthiness, but also improves the flexibility and adaptability of the network. The optimization model is reconstructed based on the preset multi-agent Markov decision process model to obtain a target optimization model; based on the observation information of each industrial device in the industrial wireless network collected in real time, the target optimization model is optimized using a preset rotating multi-agent deep reinforcement learning algorithm model, and the target parameters corresponding to each of the parameters to be optimized for scheduling the industrial wireless network are obtained, which improves the task trustworthy processing efficiency in the industrial wireless network.

The above description is only an overview of the technical solution of the present application. In order to more clearly understand the technical means of the present application so that it can be implemented according to the content of the description, and in order to make the above and other objects, features and advantages of the present application more obvious and understandable, specific embodiments of the present application are described below.

### BRIEF DESCRIPTION OF THE DRAWINGS

By reading the detailed description of the preferred embodiments below, various other advantages and benefits will become understandable to those of ordinary skill in the art. The drawings are only for the purpose of illustrating the preferred embodiments, and are not considered to be limitations on the present application. Moreover, through the drawings, the same reference symbols are used to represent the same components. In the drawings:

FIG. 1 is a schematic flowchart of a dynamic blockchain-based trustworthy scheduling method for industrial wireless networks according to an embodiment of the present application.

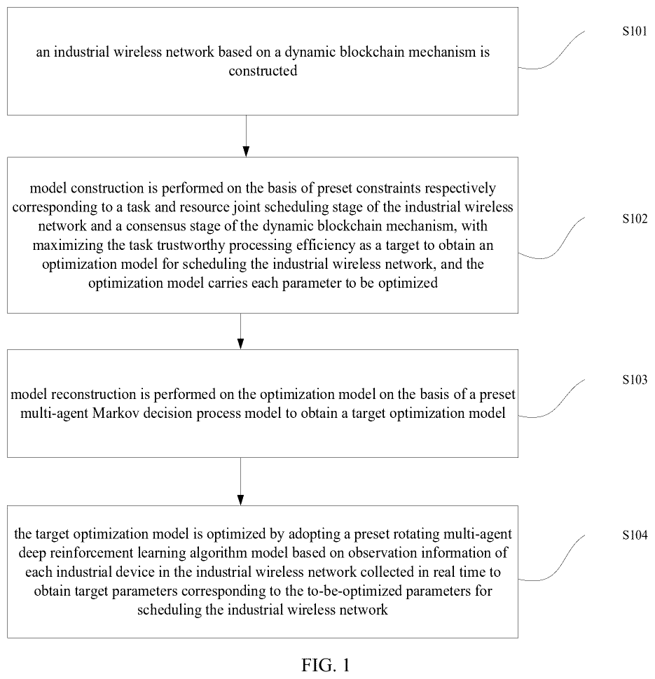

FIG. 2 is a schematic flowchart of a dynamic blockchain-based trustworthy scheduling method for industrial wireless networks according to another embodiment of the present application.

FIG. 3 is a schematic structural diagram of an industrial wireless network according to an embodiment of the present application.

FIG. 4 shows a structural diagram of a preset rotating multi-agent deep reinforcement learning algorithm model according to an embodiment of the present application.

FIG. 5 is a structural block diagram of a dynamic blockchain-based trustworthy scheduling device for industrial wireless networks according to an embodiment of the present application.

### DETAILED DESCRIPTION OF THE EMBODIMENTS

Various methods and features of the present application are described herein with reference to the accompanying drawings.

It should be understood that various modifications may be made to the embodiments of the present application. Therefore, the above description should not be construed as limitation, but merely as an example of an embodiment. A person skilled in the art would conceive of other modifications within the scope and spirit of the present application.

The accompanying drawings, which are incorporated in and constitute a part of the specification, illustrate embodiments of the present application and, together with the summary of the present application given above and the detailed description of the embodiments given below, serve to explain the principles of the present application.

These and other features of the present application will become understandable from the following description of preferred forms of embodiments given as non-limiting examples with reference to the accompanying drawings.

It should also be understood that although the present application has been described with reference to some specific examples, a person skilled in the art would have been able to determine many other equivalent forms of the present application.

The above and other aspects, features and advantages of the present application will become more understandable in view of the following detailed description when taken in conjunction with the accompanying drawings.

Hereinafter, specific embodiments of the present application are described with reference to the accompanying drawings; however, it should be understood that the embodiments of the present application are merely examples of the present application, and can be implemented in various ways. Well-known and/or repeated functions and structures are not described in detail to avoid unnecessary or redundant details that may obscure the present application. Therefore, the specific structural and functional details of the present application are not intended to be restrictive, but are merely used as the basis and representative basis of the claims to teach a person skilled in the art to use the present application in various details in any suitable detailed structure.

The description may use the phrase “in one embodiment”, “in another embodiment”, “in yet another embodiment”, or “in other embodiments”, which may each refer to one or more of the same or different embodiments according to the present application.

The embodiment of the application provides an industrial wireless network trustworthy scheduling method based on a dynamic blockchain mechanism, and the method comprises the steps S101 to S104.

In step S101, an industrial wireless network based on a dynamic blockchain mechanism is constructed.

In the implementations, the industrial wireless network comprises a plurality of edge servers and a plurality of industrial devices, the edge servers are powered by a power grid and are in wired connection with each other, and the plurality of edge servers comprise an edge computing server, a base station and a blockchain node server; and the edge computing server provides edge computing and content caching services; and the base station provides a communication service; and the blockchain node server provides trustworthiness guarantee for communication and computing services; the industrial devices generates a task, performs local computing on the task, and supports task offloading to the edge server through the wireless channel for edge computing. Here, the edge server plays two roles: a leader and a follower. The leader is responsible for verifying the transaction and generating the block, and the follower is responsible for initiating the transaction and storing the block. And the blockchain waiting time window and the leader edge server can dynamically change with the environment.

In step S102, on the basis of preset constraints respectively corresponding to a task and resource joint scheduling stage of the industrial wireless network and a consensus stage of the dynamic blockchain mechanism, model construction is performed aiming at maximizing task trustworthy processing efficiency, to obtain an optimization model for scheduling the industrial wireless network, wherein the optimization model carries to-be-optimized parameters.

In implementations, the preset constraints comprise a task division proportion constraint, a bandwidth allocation proportion constraint, a local computing frequency allocation constraint, an energy consumption constraint, a blockchain trustworthiness constraint, an edge computing frequency allocation constraint, a task deadline constraint and a trustworthiness constraint. The to-be-optimized parameters comprise a task division proportion and a bandwidth allocation proportion, and computing frequency allocated for task processing and block generation, a dynamic waiting time window and a leader edge server elected by the edge servers in the blockchain.

In step S103, model reconstruction is performed on the optimization model based on a preset multi-agent Markov decision process model to obtain a target optimization model.

In implementations, an agent set, an observation set and an action set of the preset multi-agent Markov decision process model are constructed; a preset trustworthy computing reward function, a preset timeout penalty function and a preset consensus penalty function are constructed to obtain a reward function of the preset multi-agent Markov decision process model; model construction is performed based on the agent set, the observation set, the action set and the reward function to obtain a preset multi-agent Markov decision process model; model reconstruction is performed on the optimization model based on the preset multi-agent Markov decision process model to obtain a target optimization model.

In step S104, the target optimization model is optimized by using a preset rotating multi-agent deep reinforcement learning algorithm model on the basis of observation information of each industrial device in the industrial wireless network acquired in real time, to obtain target parameters corresponding to the parameters to be optimized for scheduling the industrial wireless network.

In implementations, the observation information of each industrial device in the industrial wireless network acquired in real time is subjected to action prediction by adopting a preset rotating multi-agent deep reinforcement learning algorithm, and target parameters corresponding to each to-be-optimized parameter for scheduling the industrial wireless network is obtained; computing is performed based on the target parameters by adopting the target optimization model to obtain a target reward; the target parameters are executed to obtain target observation information of industrial devices in the next state; the observation information, the target parameters, the target reward and the target observation information are inputted into a preset experience replay buffer, laying a foundation for offline training of the preset rotating multi-agent deep reinforcement learning algorithm model in specific application.

According to the application, an industrial wireless network based on a dynamic blockchain mechanism is constructed; model construction is performed on the basis of preset constraints respectively corresponding to a task and resource joint scheduling stage of the industrial wireless network and a consensus stage of the dynamic blockchain mechanism, with maximizing the task trustworthy processing efficiency as a target, to obtain an optimization model carrying parameters to be optimized for scheduling the industrial wireless network; a dynamic blockchain mechanism is adopted, the leader edge server and the blockchain waiting time window are dynamically adjusted according to the network status and the task requirements, the security and trustworthiness are guaranteed, and the flexibility and adaptability of the network are also improved. And model reconstruction is performed on the optimization model based on a preset multi-agent Markov decision process model to obtain a target optimization model; the target optimization model optimized by adopting a preset rotating multi-agent deep reinforcement learning algorithm model based on observation information of each industrial device in the industrial wireless network collected in real time to obtain target parameters corresponding to each to-be-optimized parameter for scheduling the industrial wireless network, so that the task trustworthy processing efficiency in the industrial wireless network is improved.

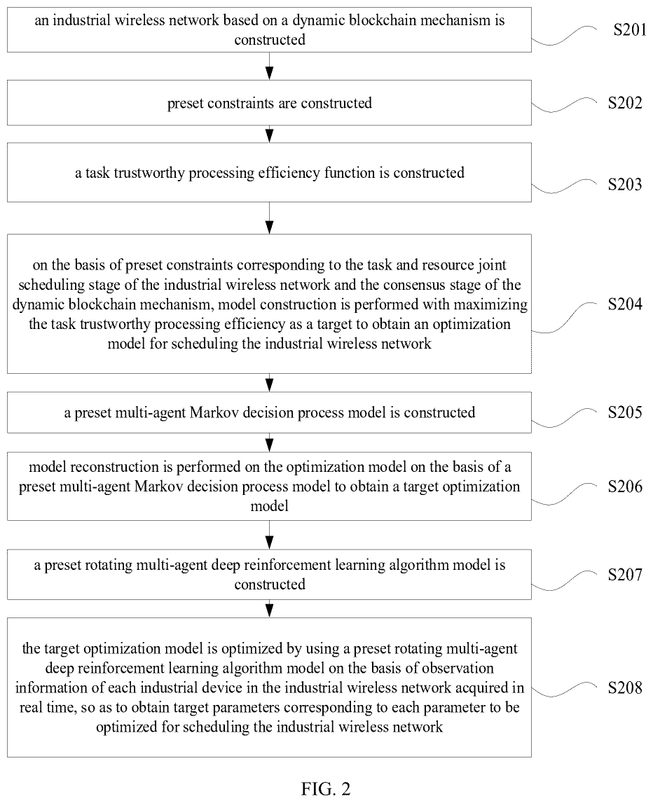

Another embodiment of the present application provides another dynamic blockchain-based trustworthy scheduling method for an industrial wireless network, as shown in FIG. 2, comprising the following steps S201 to S208.

In step S201, an industrial wireless network based on a dynamic blockchain mechanism is constructed.

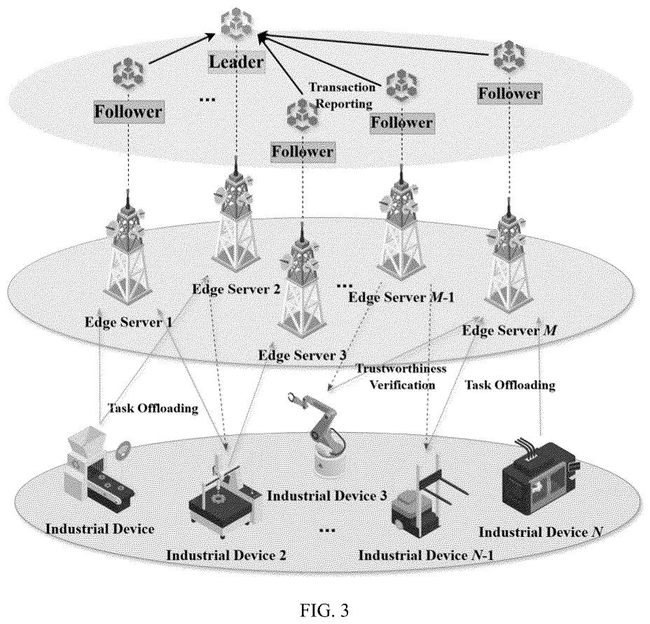

In implementations, as shown in FIG. 3, which shows a schematic structural diagram of the industrial wireless network. The industrial wireless network comprises M edge servers and N industrial devices with sets M={1, 2, . . . , M} and N={1, 2, . . . , N} respectively. The edge servers are powered by a power grid and are in wired connection with each other, and the plurality of edge servers comprise an edge computing server, a base station and a blockchain node server; the edge computing server provides edge computing and content caching services; and the base station provides a communication service; and the blockchain node server provides trustworthiness guarantee for communication and computing services; the industrial device generates a task, performs local computing on the task, and supports task offloading to edge servers through the wireless channel for edge computing. Here, the edge server plays two roles: a leader and a follower. The leader is responsible for verifying the transaction and generating the block, and the follower is responsible for initiating the transaction and storing the block. And the leader edge server and its blockchain waiting time window can dynamically change along with the environment.

In step S202, preset constraints are constructed.

In implementations, constraints are constructed based on the task division proportion of each industrial device to edge servers, and a task division proportion constraint C1 of the task and resource joint scheduling stage is obtained. The mathematical expression of the task division proportion constraint can be represented as the following formula (1):

$$C 1 : {\sum }_{m = 0}^{M} {x}_{n , m} = 1 , n ∈ N \qquad ( 1 )$$

wherein x_{n,m} is the task division proportion of the n-th industrial device to the m-th edge server, and x_{n,0} represents the local computing proportion of the task. x_{n,m}=1, indicates that the n-th industrial device offloads all the task to the m-th edge server for complete edge computing, and x_{n,m}=0 indicates that the n-th industrial device does not offload task to the m-th edge server.

The constraints are constructed based on the bandwidth allocation proportion allocated to each industrial device by each edge server to obtain a bandwidth allocation proportion constraint C2 of the task and resource joint scheduling stage, wherein the mathematical expression of the bandwidth allocation proportion constraint can be represented by the following formula (2):

$$C 2 : {\sum }_{n = 1}^{N} {r}_{n , m} \leq 1 , m ∈ M \qquad ( 2 )$$

wherein r_{n,m} represents the bandwidth allocation proportion of the task allocated by the m-th edge server to the n-th industrial device.

The constraints are constructed based on the preset maximum computing frequency parameters corresponding to the industrial devices to obtain local computing frequency constraints respectively corresponding to the industrial devices, wherein the mathematical expression of the local computing frequency constraint C3 can be represented by the following formula (3):

$$C 3 : 0 < {f}_{n} \leq {F}_{n}^{max} \qquad ( 3 )$$

wherein fₙ represents the local computing frequency of the device used by the n-th industrial device, and should not exceed the maximum local computing frequency

$${F}_{n}^{max}$$

of the n-th industrial device.

The constraints are constructed based on the computing energy consumption, the task transmission energy consumption and the maximum battery capacity respectively corresponding to the industrial devices to obtain energy consumption constraints respectively corresponding to the industrial devices, wherein the mathematical expression of the energy consumption constraint C4 can be represented by the following formula (4):

$$C 4 : {E}_{n} \leq {E}_{n}^{max} \qquad ( 4 )$$

The main energy consumption of the n-th industrial device is computing energy consumption and task transmission energy consumption, and should not exceed the maximum battery capacity

$${E}_{n}^{max}$$

owned by the industrial device.

The constraint is constructed based on a preset completed task counting function, a preset Byzantine fault tolerance coefficient, indicators of task offloading of each industrial device completed by each edge server, and a task division proportion of each industrial device offloaded to each edge server, to obtain a blockchain trustworthiness constraint C5 of the consensus stage, wherein the mathematical expression of the blockchain trustworthiness constraint C5 of the consensus stage can be represented by the following formula (5):

$$C 5 : Count ( {z}_{n , m} == 1 ) \geq ρ {\sum }_{m = 1}^{M} ⌈ {x}_{n , m} ⌉ \qquad ( 5 )$$

The blockchain trustworthiness constraint should meet the Byzantine fault tolerance mechanism; wherein Count( ) is a preset completed task counting function and is used for calculating the number of z_{n,m}==1; indicator z_{n,m}∈{−1,1} represents whether the m-th edge server completes an offloading task of the n-th industrial device in the task deadline, and ρ is a Byzantine fault tolerance coefficient. The constraint indicates that the number of transactions of completed tasks received within the allowed maximum consensus delay should not be lower than a first preset threshold. ┌ ┐ is an upward rounding symbol, and indicates that the value is rounded to the closest integer value not less than the original value.

On the basis of the maximum edge computing frequency of each edge server, a binary leader indicator and computing frequency allocated to the block generation of the leader, performing constraint construction on the edge computing frequency allocated to the block to obtain an edge computing frequency allocation constraint corresponding to each edge server. The mathematical expression of the edge computing frequency allocation constraint C6 can be represented by the following formula (6):

$$C 6 : {\sum }_{n = 1}^{N} {f}_{n , m}^{E} + {l}_{m} {f}_{m}^{B} \leq {F}_{m}^{max} , m ∈ M \qquad ( 6 )$$

wherein

$${F}_{m}^{max}$$

is the maximum edge computing frequency of the m-th edge server, lₘ={0,1} is a binary leader indicator, assuming that the leader edge server is m*, l_{m=m*}=1 and l_{m≠m*}=0;

$${f}_{n , m}^{E}$$

represents the edge computing frequency allocated to the task processing;

$${f}_{m}^{B}$$

represents the edge computing frequency allocated to the block generation when serving as a leader.

The constraints are constructed based on a preset task deadline of each industrial device to obtain a task deadline constraint C7 corresponding to each industrial device, wherein the mathematical expression of the task deadline constraint C7 can be represented by the following formula (7):

$$C 7 : {T}_{n} \leq {T}_{n}^{max} , n ∈ N \qquad ( 7 )$$

wherein

$${T}_{n}^{max}$$

is the task deadline of the n-th industrial device, that is, the maximum tolerable task processing delay of the industrial device.

The constraints are constructed based on the trust score of the completed task amount corresponding to each edge server and a preset threshold to obtain a trustworthiness constraint C8 corresponding to each edge server. The mathematical expression of the trustworthiness constraint C8 can be represented by the following formula (8):

C8: vₘ>Vₜₕ,m∈M (8)

For tasks completed by the m-th edge server, the trust score vₘ calculated on the basis of the number of successfully completed tasks should be greater than a set threshold Vₜₕ.

In step S203, a task trustworthy processing efficiency function is constructed.

In implementations, function construction is performed based on a preset trustworthiness verification delay function, a preset task transmission delay function and a preset edge computing delay function to obtain a trustworthy computing process function; specifically, function construction is carried out based on the size of the verified block, the transmission rate function between each industrial device and each edge server, and the trustworthiness verification delay function

$${T}_{n , m}^{ver}$$

is obtained; the mathematical expression of the trustworthiness verification delay function can be represented by the following formula (9):

$${T}_{n , m}^{v e r} = \frac{V B}{{R}_{n , m}} \qquad ( 9 )$$

wherein VB is the size of the verified block; R_{n,m} is a transmission rate function, and the mathematical expression of the transmission rate function can be represented by the following formula (10):

$${R}_{n , m} = {r}_{n , m} {B}_{m} {log}_{2} ( 1 + \frac{{p}_{n} {h}_{n , m}}{{r}_{n , m} {B}_{m} {N}_{0}} ) \qquad ( 10 )$$

wherein r_{n,m} represents the bandwidth allocation proportion of the m-th edge server allocated to the n-th industrial device, Bₘ represents the bandwidth of the m-th edge server, pₙ is the transmission power of the n-th industrial device, h_{n,m} is the channel power gain between the n-th industrial device and the m-th edge server, and N₀ is the noise power spectral density.

The function construction is performed on the basis of the task division proportion of each industrial device offloading to each edge server, the size of task offloaded to each edge server by each industrial device, and a transmission rate function between each industrial device and each edge server to obtain a preset task transmission delay function

$${T}_{n , m}^{trans} ;$$

the mathematical expression of the preset task transmission delay function can be represented by the following formula (11):

$${T}_{n , m}^{trans} = \frac{{x}_{n , m} {D}_{n}}{{R}_{n , m}} \qquad ( 11 )$$

wherein x_{n,m} Dₙ is the size of task offloaded to m-th edge server from the n-th industrial device.

The function construction is performed on the basis of the task division proportion of the industrial device offloading to each edge server, the computing frequency required by the task of each industrial device and the edge computing frequency allocated to the industrial device by the edge server to obtain the preset edge computing delay function

$${T}_{n , m}^{c o m p} ;$$

the mathematical expression of the preset edge computing delay function can be represented by the following formula (12):

$${T}_{n , m}^{c o m p} = \frac{{x}_{n , m} {C}_{n}}{{f}_{n , m}^{E}} \qquad ( 12 )$$

wherein Cₙ represents the computing frequency required by the task of the n-th industrial device.

The mathematical expression of the trustworthy computing process function

$${T}_{n , m}^{VC}$$

can be represented by the following formula (13):

$${T}_{n , m}^{V C} = {T}_{n , m}^{v e r} + {T}_{n , m}^{trans} + {T}_{n , m}^{c o m p} \qquad ( 13 )$$

The function construction is performed based on the trustworthy computing process function, a preset transaction record report delay function, a preset maximum consensus waiting delay function, and a preset practical maximum consensus waiting delay function to obtain an actual consensus waiting delay function; specifically, performing function construction based on the transmission rate R_{m,m*} between the transaction record size TR and the edge server to obtain a preset transaction record report delay function

$${T}_{m , {m}^{*}}^{TR} ,$$

wherein the mathematical expression of the preset transaction record report delay function can be represented by the following formula (14):

$${T}_{m , {m}^{*}}^{T R} = \frac{T R}{{R}_{m , {m}^{*}}} \qquad ( 14 )$$

Function construction is performed based on the trustworthy computing process function

$${T}_{n , m}^{VC} ,$$

the preset transaction record report delay function

$${T}_{m , {m}^{*}}^{T R}$$

and the dynamic waiting time window

$${T}_{n}^{W N D}$$

to obtain an allowed maximum consensus waiting delay function

$${T}_{n}^{A C W} ,$$

wherein the mathematical expression of the allowed maximum consensus waiting delay function can be represented by the following formula (15):

$${T}_{n}^{A C W} = {min}_{m ∈ M} ( {T}_{n , m}^{V C} + {T}_{m , {m}^{*}}^{T R} ) + {T}_{n}^{W N D} \qquad ( 15 )$$

The function construction is performed based on the trustworthy computing process function

$${T}_{n , m}^{VC}$$

and the preset transaction record report delay function

$${T}_{m , {m}^{*}}^{TR}$$

to obtain an practical maximum consensus waiting delay function

$${T}_{n}^{PCW} ,$$

wherein the mathematical expression of the practical maximum consensus waiting delay function can be represented by the following formula (16):

$${T}_{n}^{PCW} = {max}_{m ∈ M} ( {T}_{n , m}^{VC} + {T}_{m , {m}^{*}}^{TR} ) \qquad ( 16 )$$

The function construction is performed based on the allowed maximum consensus waiting delay function

$${T}_{n}^{ACW}$$

and the practical maximum consensus waiting delay function

$${T}_{n}^{PCW}$$

to obtain the actual consensus waiting delay function

$${T}_{n}^{CW} ;$$

the mathematical expression of the actual consensus waiting delay function can be represented by the following formula (17):

$${T}_{n}^{CW} = min ( {T}_{n}^{ACW} , {T}_{n}^{PCW} ) , n ∈ N \qquad ( 17 )$$

The function construction is performed on the basis of the actual consensus waiting delay function

$${T}_{n}^{CW}$$

and a preset block generation delay function

$${T}_{n}^{BG}$$

to obtain a trustworthy edge computing delay function

$${T}_{n}^{edge} ;$$

the mathematical expression of the trustworthy edge computing delay function may be represented by the following formula (18):

$${T}_{n}^{edge} = {T}_{n}^{CW} + {T}_{n}^{BG} , n ∈ N \qquad ( 18 )$$

The mathematical expression of the preset block generation delay function

$${T}_{n}^{BG}$$

can be represented by the following formula (19):

$${T}_{n}^{BG} = ⌈ \frac{{N}^{TR} \times V B}{N} ⌉ \frac{V B}{{f}_{{m}^{*}}^{B}} \qquad ( 19 )$$

wherein

$${f}_{{m}^{*}}^{B}$$

is the edge computing frequency allocated by the leader to generate the block.

The function construction is performed on the basis of the trustworthy edge computing delay function

$${T}_{n}^{edge}$$

and a local computing delay function

$${T}_{n}^{end}$$

corresponding to each industrial device to obtain a trustworthy task computing delay function Tₙ corresponding to each industrial device. The mathematical expression of the trustworthy task computing delay function may be represented by the following formula (20):

$${T}_{n} = max ( {T}_{n}^{end} , {T}_{n}^{edge} ) , n ∈ N \qquad ( 20 )$$

The function construction is performed on the basis of a trustworthy task computing delay function Tₙ and a task size Dₙ corresponding to the same industrial device to obtain a mathematical expression of the trustworthy processing efficiency function Uₙ corresponding to the same industrial device, wherein the mathematical expression of the trustworthy processing efficiency function can be represented by the following formula (21):

$${U}_{n} = \frac{{D}_{n}}{{T}_{n}} , n ∈ N \qquad ( 21 )$$

In step S204, on the basis of preset constraints corresponding to the task and resource joint scheduling stage of the industrial wireless network and the consensus stage of the dynamic blockchain mechanism, model construction is performed with maximizing the task trustworthy processing efficiency as a target to obtain an optimization model for scheduling the industrial wireless network.

In implementations, the mathematical expression of the optimization model can be represented by the following formula (22):

$${Maximize}_{X , R , F , T , L} {\sum }_{n = 1}^{N} {U}_{n} \qquad ( 22 )$$

wherein the optimization model represents maximization of task trustworthy processing efficiency. X, R, F, T, L are to-be-optimized parameter sets, X={x_{n,m}}_{M×N} is a set of task division proportions, R={r_{n,m}}_{M×N} is a set of bandwidth allocation proportions,

$$F = \{ {\{ {f}_{n , m}^{E} \}}_{M \times N} , {f}_{{m}^{*}}^{B} \}$$

is a set of computing frequency allocated to task computing and block generation,

$$T = {\{ {T}_{n}^{WND} \}}_{N}$$

is a set of dynamic waiting time windows in the blockchain, and L={lₘ}_{M} is a set of leaders elected by all edge servers.

In step S205, a preset multi-agent Markov decision process model is constructed.

In implementations, an agent set, an observation set and an action set of the preset multi-agent Markov decision process model are constructed. Specifically, the agent set is M={1, 2, . . . , M}, that is, each edge server is regarded as an agent, an optimal action strategy of the edge server is learned by observing the environment state, and the optimal action strategy and other agents cooperate to achieve the maximum trustworthy processing efficiency of the task. The observation set comprises a task state, an industrial device state and an edge server state, wherein at each time slot t, the task state comprises a task size Dₙ(t), a required computing frequency Cₙ(t) and a task deadline

$${T}_{n}^{max} ( t ) ;$$

the industrial device state comprises a transmission power pₙ(t), a channel power gain h_{n,m} (t), a maximum battery capacity

$${E}_{n}^{max} ( t )$$

and maximum local computing frequency

$${F}_{n}^{max} ( t ) ;$$

the edge server state comprises a maximum edge computing frequency

$${F}_{m}^{max} ( t ) ,$$

a bandwidth Bₘ(t) and a trust score vₘ(t). Therefore, the whole environment state can be represented by the following formula (23):

$$( 23 )$$

$$S ( t ) = \{ {D}_{n} ( t ) , {C}_{n} ( t ) , {T}_{n}^{max} ( t ) , {p}_{n} ( t ) , {h}_{n , m} ( t ) , {E}_{n}^{max} ( t ) , {F}_{n}^{max} ( t ) , {F}_{m}^{max} ( t ) , {B}_{m} ( t ) , {v}_{m} ( t ) \}$$

By observing the environment state, each agent obtains its own observation, which is expressed as Sₘ(t), and the mathematical expression of the action strategy set can be represented by the following formula (24):

$$A ( t ) = \{ {x}_{n , m} ( t ) , {r}_{n , m} ( t ) , {f}_{n , m}^{E} ( t ) , {f}_{m}^{B} ( t ) , {T}_{n}^{WND} ( t ) , {l}_{m} ( t ) \} \qquad ( 24 )$$

The method relates to a task division proportion x_{m,n}(t), bandwidth allocation proportion r_{m,n}(t), edge computing frequency allocation

$${f}_{n , m}^{B} ( t ) and {f}_{m}^{B} ( t ) ,$$

a consensus waiting time window

$${T}_{n}^{WND} ( t )$$

and a leader election lₘ(t).

The mathematical expression of the preset trustworthy computing reward function can be represented by the following formula (25):

$${P}_{n} ( t ) = α {P}_{n}^{comp} ( t ) + β {P}_{n}^{cons} ( t ) \qquad ( 25 )$$

wherein

$${P}_{n}^{comp} ( t )$$

is a timeout penalty,

$${P}_{n}^{cons} ( t )$$

is a penalty of consensus failure, α and β are respectively penalized weight factors. The mathematical expression of the penalty

$${P}_{n}^{comp} ( t )$$

for calculating the timeout may be represented by the following formula (26):

$${P}_{n}^{comp} ( t ) = - {\sum }_{n = 1}^{N} min ( \frac{{T}_{n} - {T}_{n}^{max}}{{T}_{n}^{max}} , 1 ) \qquad ( 26 )$$

The mathematical expression of the consensus penalty

$${P}_{n}^{cons} ( t )$$

of consensus failure can be represented by the following formula (27):

$${P}_{n}^{cons} ( t ) = \{ \begin{matrix}0 , & if C 5 is met \\ - 1 , & otherwise\end{matrix} \qquad ( 27 )$$

Function construction is performed based on a preset trustworthy computing reward function, a preset timeout penalty function and a preset consensus penalty function to obtain a reward function of the preset multi-agent Markov decision process model, wherein the mathematical expression of the reward function can be represented by the following formula (28):

$$R ( t ) = {\sum }_{n = 1}^{N} ( {U}_{n} ( t ) + {P}_{n} ( t ) ) \qquad ( 28 )$$

On the basis of the agent set, the observation set, the action set and the reward function, model construction is performed to obtain the preset multi-agent Markov decision process model.

In step S206, model reconstruction is performed on the optimization model on the basis of a preset multi-agent Markov decision process model to obtain a target optimization model.

In implementations, the mathematical expression of the target optimization model can be represented by the following formula (29):

$${Maximixe}_{X , R , F , T , L} R \qquad ( 29 )$$

$$s . t . C 1 - C 8$$

The long-term cumulative reward needs to be maximized under the condition that the constraints are met, that is, the trustworthy processing efficiency of the task is maximized.

In step S207, a preset rotating multi-agent deep reinforcement learning algorithm model is constructed.

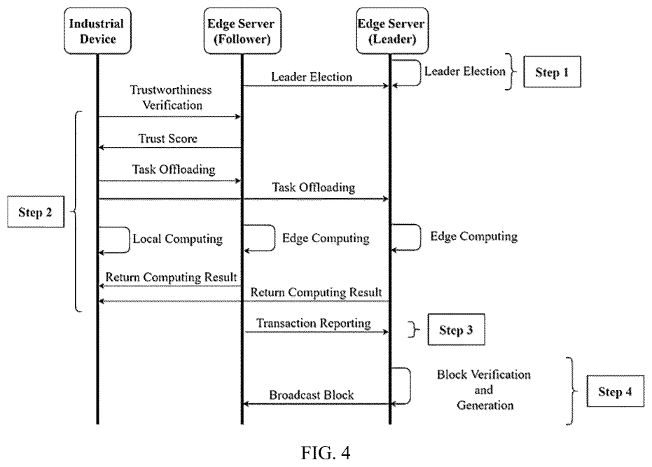

In implementations, as shown in FIG. 4, an initial model corresponding to each edge server is constructed for a preset rotating multi-agent deep reinforcement learning algorithm model structure diagram, and the initial model comprises an initial actor neural network, two initial critic neural networks and two initial target critic neural networks.

The initial model corresponding to a preset initial leader edge server is initialized to obtain an initial model parameter corresponding to the initial leader edge server.

Based on each piece of historical experience data, each initial model parameter, a preset first loss function, a preset second loss function, a preset third loss function and a preset entropy regularization loss function, performing model training on each initial model to obtain a target deep reinforcement learning model corresponding to each edge server, so as to obtain the preset rotating multi-agent deep reinforcement learning algorithm model; specifically, in the first time slot, performing leader election based on the initial edge computing frequency, the initial trust score and the initial channel state of each edge server to obtain an initial leader edge server, wherein the calculation mathematical formula of the initial trust score vₘ is as shown in the following formula (30):

$${v}_{m} = \frac{{\sum }_{n = 1}^{N} {𝓏}_{n , m} {x}_{n , m} {C}_{n}}{{\sum }_{n = 1}^{N} {C}_{n}} , m ∈ M \qquad ( 30 )$$

wherein z_{n,m} ∈{1,−1} represents whether the m-th edge server completes the offloading task of the n-th industrial device. 1 is completed, and −1 is not completed.

On the basis of a preset first loss function, a preset second loss function, a preset third loss function and a preset entropy regularization loss function, model training is performed on the initial model corresponding to the initial leader edge server to obtain a current first model corresponding to the initial leader edge server; specifically, calculation is performed by adopting the first loss function based on a group of historical experience data randomly extracted to obtain a first model parameter of the first initial critic neural network; calculation is performed by using the second loss function based on another group of historical experience data extracted randomly to obtain a second model parameter of a second initial critic neural network, wherein the first model parameter is obtained by minimizing first loss function, and the second model parameter is obtained by minimizing the second loss function. The mathematical calculation formula of the first loss function can be represented by the following formula (31):

$${L}_{Q} ( {ω}_{1} ) = {E}_{{Ω}^{λ} ( t )} [ {\frac{1}{2} [ {Q}_{{ω}_{1}} ( S ( t ) , A ( t ) ) - ( R ( t ) + γ ( {min}_{j = 1 , 2} {Q}_{{ω}_{j}^{t}} , ( S ( t + 1 ) , A ( t + 1 ) ) - μ log π ( A ( t + 1 ) \vert S ( t + 1 ) ) ) ) ]}^{2} ] \qquad ( 31 )$$

wherein ω₁ is the first model parameter; Ω^{λ}(t)={S(t), A(t), R(t), S(t+1)} is a λ group of historical experience data, wherein S(t) is the observation of all the agents at the time slot t, namely the state of the whole network; A(t) is an action set at the time slot t; R(t) is a reward set obtained by executing the actions at the time slot t; and S(t+1) is the state set of the whole industrial wireless network at the next time slot after the action at the time slot t. Q_{ω}_{₁} is a first initial critic neural network; μ is an entropy regularization coefficient; E_{Ω}_{^{λ}}₍ₜ₎ is an expected value calculation function; γ is a discount factor. The mathematical calculation formula of the second loss function L_{Q}(ω₂) can be represented by the following formula (32):

$${L}_{Q} ( {ω}_{2} ) = {E}_{{Ω}^{λ} ( t )} [ {\frac{1}{2} [ {Q}_{{ω}_{2}} ( S ( t ) , A ( t ) ) - ( R ( t ) + γ ( {min}_{j = 1 , 2} {Q}_{{ω}_{j}^{t}} , ( S ( t + 1 ) , A ( t + 1 ) ) - μ log π ( A ( t + 1 ) \vert S ( t + 1 ) ) ) ) ]}^{2} ] \qquad ( 32 )$$

wherein ω₂ is the second model parameter, and Q_{ω}_{₂} is a second initial critic neural network.

The first model parameters and the second model parameters are screened to obtain target model parameters; the first model parameters are compared with the second model parameters, and it is determined that the smaller model parameters are target model parameters. Calculation is performed on the basis of the target model parameter and the historical experience data by using a third loss function of an initial actor neural network to obtain a third model parameter 6 when the loss value of the third loss function is minimum; the mathematical expression of the third loss function may be represented by the following formula (33):

$${L}_{π} ( θ ) = {E}_{{Ω}^{λ} ( t ) , ε \sim G} [ μ log ( {π}_{θ} ( {f}_{θ} ( ε ; S ( t ) ) \vert S ( t ) ) ) - {min}_{j = 1 , 2} {Q}_{{ω}_{j}} ( S ( t ) , {f}_{θ} ( ò ; S ( t ) ) ) ] \qquad ( 33 )$$

wherein θ is the third model parameter; π_{θ} is an initial actor neural network; and f_{θ} is a reparameterization function and is used for action sampling. ε is a noise random variable, and the strategy Gaussian distribution G is met.

Calculation is performed by adopting a preset entropy regularization loss function based on the historical experience data to obtain a regularization coefficient with the minimum loss value of the preset entropy regularization loss function. The mathematical expression of the preset entropy regularization loss function can be represented by the following formula (34):

$$L ( μ ) = {E}_{{Ω}^{λ} ( t )} [ - μ log π ( A ( t ) \vert S ( t ) ) - μ {H}_{0} ] \qquad ( 34 )$$

wherein H₀ is a target entropy.

Model updating is performed based on the first model parameter, the second model parameter, the third model parameter and the regularization coefficient to obtain a first current critic neural network, a second current critic neural network, a current actor model and a current entropy regularization loss function; specifically, a first initial critic neural network is updated based on the first model parameter to obtain a first current critic neural network; a second initial critic neural network is updated based on the second model parameter to obtain a second current critic neural network; the initial actor neural network is updated based on the third model parameter to obtain a current actor model; and the preset entropy regularization loss function is updated based on the regularization coefficient to obtain a current entropy regularization loss function. Specifically, each model can be updated by using the following soft update function, and the mathematical expression of the soft update function can be represented by the following formula (35):

$${ω}_{j}^{t} ← τ {ω}_{j} + ( 1 - τ ) {ω}_{j}^{t} , j = \{ 1 , 2 \} \qquad ( 35 )$$

wherein τ∈[0,1] is a parameter updating rate.

The first current critic neural network, the second current critic neural network, the current actor model and the current entropy regularization loss function are iteratively updated until each reward obtained by performing action prediction on each piece of historical experience data by adopting the updated current actor model meets a preset constraint to obtain the current first model. Model parameters of the current first model are sent to each first edge server of the non-initial leader edge server so as to perform model updating on an initial model corresponding to each first edge server based on the model parameters to obtain a current first model corresponding to each first edge server, wherein the model parameters comprise a first model parameter, a second model parameter, a third model parameter and a first entropy regularization coefficient corresponding to the initial leader edge server; and in a non-first time slot, re-elect leader based on the current edge computing frequency, the current trust score and the current channel state of each edge server to obtain a current leader edge server; and based on a preset first loss function, a preset second loss function, a preset third loss function and a preset entropy regularization loss function, performing model training on the current first model corresponding to the current leader edge server so as to update the current first model; and the updated model parameters of the current first model are sent to each second edge server of the non-current leader edge server so as to perform model updating and loop iteration on the current first model corresponding to each second edge server based on the model parameters until the algorithm converges, and training is performed to obtain the preset rotating multi-agent deep reinforcement learning algorithm model. The target deep reinforcement learning model comprises: a target actor neural network, two critic neural networks, and two target critic neural networks used for stabilizing the critic neural network respectively corresponding to each critic neural network.

In step S208, the target optimization model is optimized by using a preset rotating multi-agent deep reinforcement learning algorithm model on the basis of observation information of each industrial device in the industrial wireless network acquired in real time, so as to obtain target parameters corresponding to each parameter to be optimized for scheduling the industrial wireless network.

In implementations, the observation information of each industrial device in the industrial wireless network acquired in real time is subjected to action prediction by adopting a preset rotating multi-agent deep reinforcement learning algorithm model to obtain each target parameter value meeting each piece of observation information; calculating based on each target parameter value by adopting an optimization model for scheduling the industrial wireless network to obtain a target reward; executing the target parameter value to obtain target observation information of each industrial device in the next state; inputting each piece of observation information, each target action parameter, the target reward and the target observation information into a preset experience replay buffer; and laying a foundation for offline updating of the preset rotating multi-agent deep reinforcement learning algorithm model in specific application.

The end-edge collaborative trustworthy computing process adopted in the present application, as shown in FIG. 4, mainly comprises the following steps.

In step 1, an edge server executes dynamic leader edge server election and establishes a trustworthy blockchain.

In step 2, the industrial device verifies the trustworthiness of the task offloading target edge server, and executes task offloading to carry out end-edge collaborative trustworthy computing.

In step 3, the follower agent reports a transaction record to the leader edge server, and waits to reach a consensus.

In step 4, the leader intelligently verifies the transaction record to generate block, and broadcasts the verified block to update the blockchain.

According to the application, a dynamic leader election and dynamic consensus waiting mechanism is carried out in an end-edge collaborative trustworthy computing environment. The leader edge server and the blockchain waiting time window can be dynamically adjusted according to the network state and the task requirement, so that the security and trustworthiness are guaranteed, and the flexibility and adaptability of the network are also improved. Communication, computing, energy resources, trustworthiness and the like are comprehensively considered, task division proportion, bandwidth allocation proportion and edge computing frequency allocation, leader and waiting time window are jointly optimized, scheduling of tasks and resources can be dynamically adjusted according to changes of scenes, and task processing can be efficiently completed while security and trustworthiness are guaranteed. A preset rotating training distributed execution architecture is adopted, so that the trustworthy processing efficiency of tasks in the industrial wireless network is improved.

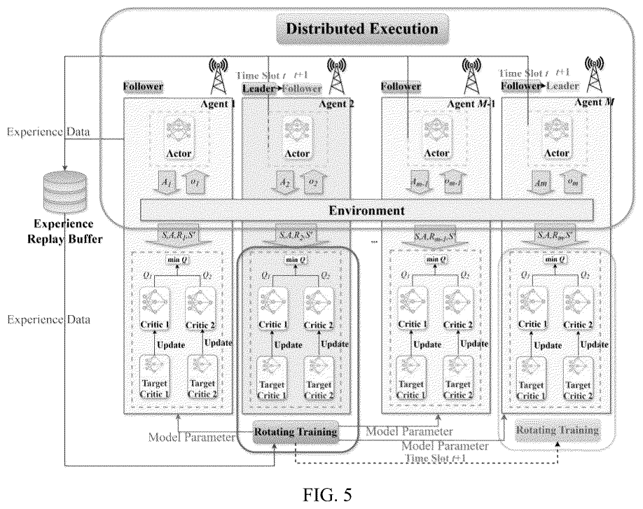

Another embodiment of the present application provides an industrial wireless network trustworthy scheduling apparatus based on a dynamic blockchain mechanism, as shown in FIG. 5, comprising: an industrial wireless network construction module 1 configured to construct an industrial wireless network based on a dynamic blockchain mechanism; a model construction module 2, configured to perform model construction on the basis of preset constraints respectively corresponding to a task and resource joint scheduling stage of the industrial wireless network and a consensus stage of the dynamic blockchain mechanism, with maximizing the task trustworthy processing efficiency as a target to obtain an optimization model for scheduling the industrial wireless network, wherein the optimization model carries parameters to be optimized; a model reconstruction module 3 configured to perform model reconstruction on the optimization model based on a preset multi-agent Markov decision process model to obtain a target optimization model; and an optimization module 4, configured to optimize the target optimization model by using a preset rotating multi-agent deep reinforcement learning algorithm model on the basis of observation information of each industrial device in the industrial wireless network collected in real time, so as to obtain target parameters corresponding to each parameter to be optimized for scheduling the industrial wireless network.

In implementations, the industrial wireless network trustworthy scheduling device based on the dynamic blockchain further comprises a preset constraint construction module, and each preset constraint construction module is specifically used for constructing constraints based on the task division proportion of each industrial device offloaded to each edge server to obtain a task division proportion constraint of the task and resource joint scheduling stage; and constraint construction is performed based on the bandwidth allocation proportion allocated to each industrial device by each edge server to obtain a bandwidth allocation proportion constraint of the task and resource joint scheduling stage; and constraint construction is performed based on preset maximum local computing frequency parameters corresponding to the industrial device to obtain local computing frequency constraints respectively corresponding to the industrial device; and constraint construction is performed based on the computing energy consumption, the task transmission energy consumption and the maximum battery capacity respectively corresponding to the industrial device to obtain energy consumption constraints respectively corresponding to the industrial device; and constraint construction is performed based on a preset success processing task count function of the dynamic blockchain mechanism, a preset Byzantine fault tolerance coefficient, indicators of task offloading of each industrial device completed by each edge server, and a task division proportion of each industrial device offloaded to each edge server to obtain a blockchain trustworthiness constraint of the consensus stage; and based on the maximum edge computing frequency of each edge server, whether each edge server is a binary leader indicator, and each edge server acts as a leader to carry out constraint construction on the edge computing frequency allocated to the block generation to obtain an edge computing frequency allocation constraint corresponding to each edge server; constraint construction is performed based on a preset task deadline of each industrial device to obtain a task deadline constraint corresponding to each industrial device; and constraint construction is performed based on the trust score of the completed task amount corresponding to each edge server and a preset threshold to obtain a trustworthiness constraint corresponding to each edge server.

In implementations, the industrial wireless network trustworthy scheduling device based on the dynamic blockchain further comprises a trustworthy processing efficiency function construction module, and the trustworthy processing efficiency function construction module is specifically used for constructing a function based on a preset trustworthiness verification delay function, a preset task transmission delay function and a preset edge computing delay function to obtain a trustworthy computing process function; and based on the trustworthy computing process function and a preset transaction record report delay function, presetting an allowed maximum consensus waiting delay function, and presetting an practical maximum consensus waiting delay function for function construction to obtain a practical consensus waiting delay function; and performing function construction based on the practical consensus waiting delay function and a preset block generation delay function to obtain an edge trustworthy computing delay function; performing function construction based on the edge trustworthy computing delay function and a local computing delay function corresponding to each industrial device to obtain a task trustworthy computing delay function corresponding to each industrial device; and performing function construction based on the task trustworthy computing delay function and the task size corresponding to the same industrial device to obtain the trustworthy processing efficiency function corresponding to the same industrial device.

In implementations, the industrial wireless network trustworthy scheduling device based on the dynamic blockchain further comprises a preset multi-agent Markov decision process model construction module, and the preset multi-agent Markov decision process model construction module is specifically used for constructing an agent set, an observation set and an action set of the preset multi-agent Markov decision process model; function construction is performed based on a preset trustworthy computing reward function, a preset timeout penalty function and a preset consensus penalty function to obtain a reward function of the preset multi-agent Markov decision process model; and model construction is performed based on the agent set, the observation set, the action set and the reward function to obtain the preset multi-agent Markov decision process model.

In implementations, the industrial wireless network trustworthy scheduling device based on the dynamic blockchain further comprises a preset rotating multi-agent deep reinforcement learning algorithm model construction module, and the preset rotating multi-agent deep reinforcement learning algorithm model construction module is specifically used for constructing an initial model corresponding to each edge server, wherein the initial model comprises an initial actor neural network, two initial critic neural networks and two initial target critic neural networks; and the initial model corresponding to a preset initial leader edge server in each edge server is initialized to obtain an initial model parameter corresponding to the initial leader edge server; and based on each piece of historical experience data, each initial model parameter, a preset first loss function, a preset second loss function, a preset third loss function and a preset entropy regularization loss function, model training is performed on each initial model to obtain a target deep reinforcement learning model corresponding to each edge server, so as to obtain the preset rotating multi-agent deep reinforcement learning algorithm model; wherein the target deep reinforcement learning model comprises a target actor neural network, each critic neural network and a target critic neural network respectively corresponding to each critic neural network and used for stabilizing the critic neural network.

In implementations, the preset rotating multi-agent deep reinforcement learning algorithm model construction module is further used for carrying out leader election based on the initial edge computing frequency, the initial trust score and the initial channel state of each edge server in the first time slot to obtain an initial leader edge server; and model training is performed on the initial model corresponding to the initial leader edge server based on a preset first loss function, a preset second loss function, a preset third loss function and a preset entropy regularization loss function to obtain a current first model corresponding to the initial leader edge server; and model parameters of the current first model are sent to each first edge server of the non-initial leader edge server so as to perform model updating on an initial model corresponding to each first edge server based on the model parameters to obtain a current first model corresponding to each first edge server, wherein the model parameters comprise a first model parameter, a second model parameter, a third model parameter and a first entropy regularization coefficient corresponding to the initial leader edge server; and in a non-first time slot, leader election is conducted again based on the current edge computing frequency, the current trust score and the current channel state of each edge server to obtain a current leader edge server; and based on a preset first loss function, a preset second loss function, a preset third loss function and a preset entropy regularization loss function, model training is performed on the current first model corresponding to the current leader edge server so as to update the current first model; and the updated model parameters of the current first model are sent to each second edge server of the non-current leader edge server, so as to perform model updating and loop iteration on the current first model corresponding to each second edge server based on the model parameters until the algorithm converges, and training to obtain the preset rotating multi-agent deep reinforcement learning algorithm model.

In implementations, the optimization module 4 is configured to perform action prediction by adopting a target actor neural network in a preset rotating multi-agent deep reinforcement learning algorithm model based on observation information of each industrial device in the industrial wireless network collected in real time, and obtain target parameters corresponding to each to-be-optimized parameter for scheduling the industrial wireless network; wherein the to-be-optimized parameters comprise a task division proportion and a communication bandwidth allocation proportion, and the edge computing frequency edge server allocating for offload task processing and block generation, a dynamic waiting time window and a leader edge server in the blockchain.

According to the application, an industrial wireless network based on a dynamic blockchain mechanism is constructed; model construction is performed on the basis of preset constraints respectively corresponding to a task and resource joint scheduling stage of the industrial wireless network and a consensus stage of the dynamic blockchain mechanism with maximizing the task trustworthy processing efficiency as a target to obtain an optimization model for scheduling the industrial wireless network, the optimization model carries parameters to be optimized; a dynamic blockchain mechanism is adopted, the leader edge server and the blockchain waiting time window are dynamically adjusted according to the network state and the task requirement, the security and trustworthiness are guaranteed, and the flexibility and adaptability of the network are also improved. Model reconstruction is performed on the optimization model based on a preset multi-agent Markov decision process model to obtain a target optimization model; and optimizing the target optimization model by adopting a preset rotating multi-agent deep reinforcement learning algorithm model based on observation information of each industrial device in the industrial wireless network collected in real time to obtain target parameters corresponding to each to-be-optimized parameter for scheduling the industrial wireless network, so that the trustworthy processing efficiency of the task in the industrial wireless network is improved.

Another embodiment of the present application provides a storage medium. The storage medium stores a computer program, and the following method steps are implemented when the computer program is executed by a processor.

In step 1, an industrial wireless network based on a dynamic blockchain mechanism is constructed.

In step 2, model construction is performed on the basis of preset constraints respectively corresponding to a task and resource joint scheduling stage of the industrial wireless network and a consensus stage of the dynamic blockchain mechanism, with maximizing the task trustworthy processing efficiency as a target to obtain an optimization model for scheduling the industrial wireless network, and the optimization model carries each parameter to be optimized.

In step 3, model reconstruction is performed on the optimization model on the basis of a preset multi-agent Markov decision process model to obtain a target optimization model.

In step 4, the target optimization model is optimized by adopting a preset rotating multi-agent deep reinforcement learning algorithm model based on observation information of each industrial device in the industrial wireless network collected in real time to obtain target parameters corresponding to the to-be-optimized parameters for scheduling the industrial wireless network.

A person skilled in the art can clearly understand that for convenience and conciseness of description, only the division of the functional units and modules is used for illustration, and in practical application, the functions can be distributed by different functional units and modules according to needs, that is, the internal structure of the device is divided into different functional units or modules to complete all or part of the functions described above.

For the specific implementation of the method steps, reference can be made to any embodiment of the industrial wireless network trustworthy scheduling method based on the dynamic blockchain, and the embodiment is not repeated herein.

According to the application, an industrial wireless network based on a dynamic blockchain mechanism is constructed; performing model construction on the basis of preset constraints respectively corresponding to a task and resource joint scheduling stage of the industrial wireless network and a consensus stage of the dynamic blockchain mechanism, so as to maximize the task trustworthy processing efficiency as a target to obtain an optimization model for scheduling the industrial wireless network, the optimization model carrying each parameter to be optimized; a dynamic blockchain mechanism is adopted, the leader edge server and the blockchain waiting time window are dynamically adjusted according to the network state and the task requirement, the security and trustworthiness are guaranteed, and the flexibility and adaptability of the network are also improved. And performing model reconstruction on the optimization model based on a preset multi-agent Markov decision process model to obtain a target optimization model; optimizing the target optimization model by adopting a preset rotating multi-agent deep reinforcement learning algorithm model based on observation information of each industrial device in the industrial wireless network collected in real time to obtain target parameters corresponding to each to-be-optimized parameter for scheduling the industrial wireless network, and improving the trustworthy processing efficiency of the task in the industrial wireless network.

Another embodiment of the present application provides an electronic device, at least comprising a memory and a processor, the memory storing a computer program, and the processor implementing the following method steps when executing the computer program on the memory.

In step 1, an industrial wireless network based on a dynamic blockchain mechanism is constructed.

In step 2, model construction is performed on the basis of preset constraints respectively corresponding to a task and resource joint scheduling stage of the industrial wireless network and a consensus stage of the dynamic blockchain mechanism, with maximizing the task trustworthy processing efficiency as a target to obtain an optimization model for scheduling the industrial wireless network, and the optimization model carries each parameter to be optimized.

In step 3, model reconstruction is performed on the optimization model on the basis of a preset multi-agent Markov decision process model to obtain a target optimization model.

In step 4, the target optimization model is optimized by adopting a preset rotating multi-agent deep reinforcement learning algorithm model based on observation information of each industrial device in the industrial wireless network collected in real time to obtain target parameters corresponding to the to-be-optimized parameters for scheduling the industrial wireless network.

For the specific implementation process of the method steps, reference can be made to any embodiment of the industrial wireless network trustworthy scheduling method based on the dynamic blockchain, and the embodiment is not repeated herein.

According to the application, an industrial wireless network based on a dynamic blockchain mechanism is constructed; performing model construction on the basis of preset constraints respectively corresponding to a task and resource joint scheduling stage of the industrial wireless network and a consensus stage of the dynamic blockchain mechanism, so as to maximize the task trustworthy processing efficiency as a target to obtain an optimization model for scheduling the industrial wireless network, the optimization model carrying each parameter to be optimized; a dynamic blockchain mechanism is adopted, the leader edge server and the blockchain waiting time window are dynamically adjusted according to the network state and the task requirement, the security and trustworthiness are guaranteed, and the flexibility and adaptability of the network are also improved. And performing model reconstruction on the optimization model based on a preset multi-agent Markov decision process model to obtain a target optimization model; optimizing the target optimization model by adopting a preset rotating multi-agent deep reinforcement learning algorithm model based on observation information of each industrial device in the industrial wireless network collected in real time to obtain target parameters corresponding to each to-be-optimized parameter for scheduling the industrial wireless network, and improving the trustworthy processing efficiency of the task in the industrial wireless network.

The above embodiments are merely exemplary embodiments of the present application and are not intended to limit the present application, and the scope of protection of the present application is defined by the claims. A person skilled in the art can make various modifications or equivalent replacements to the present application within the spirit and scope of the present application, and such modifications or equivalent replacements should also be considered to fall within the scope of protection of the present application.

What is claimed is:

1. A dynamic blockchain-based trustworthy scheduling method for an industrial wireless network, comprising:
constructing an industrial wireless network based on a dynamic blockchain mechanism;
performing model construction on the basis of preset constraints respectively corresponding to a task and resource joint scheduling stage of the industrial wireless network and a consensus stage of the dynamic blockchain mechanism with maximizing task trustworthy processing efficiency as a target, to obtain an optimization model for scheduling the industrial wireless network, the optimization model carrying parameters to be optimized;
performing model reconstruction on the optimization model based on a preset multi-agent Markov decision process model to obtain a target optimization model; and
optimizing the target optimization model using a preset rotating multi-agent deep reinforcement learning algorithm model on the basis of observation information of industrial devices in the industrial wireless network collected in real time, to obtain target parameters corresponding to the parameters to be optimized for scheduling the industrial wireless network.

2. The method according to claim 1, wherein before the performing model construction on the basis of preset constraints respectively corresponding to a task and resource joint scheduling stage of the industrial wireless network and a consensus stage of the dynamic blockchain mechanism with maximizing task trustworthy processing efficiency as a target, the method further comprises: constructing the preset constraints comprising:
performing constraint construction based on a task division proportion of each industrial devices offloaded to each edge server to obtain a task division proportion constraint of the task and resource joint scheduling stage;
performing constraint construction based on a bandwidth allocation proportion allocated to each industrial device by each edge server to obtain a bandwidth allocation proportion constraint of the task and resource joint scheduling stage;
performing constraint construction based on preset maximum local computing frequency parameters respectively corresponding to the industrial devices to obtain local computing frequency constraints respectively corresponding to the industrial devices;
performing constraint construction based on the computing energy consumption, the task transmission energy consumption and the maximum battery capacity respectively corresponding to the industrial devices to obtain energy consumption constraints respectively corresponding to the industrial devices;
performing constraint construction based on a preset completed task counting function, a preset Byzantine fault tolerance coefficient, indicators of task offloading of each industrial device completed by each edge server, and a task division proportion of each industrial device offloaded to each edge server, to obtain a blockchain trustworthiness constraint of the consensus stage;
performing constraint construction based on a maximum edge computing frequency of each edge server, a binary leader indicator, and an edge computing frequency allocated to the block generation when each edge server serves as a leader, to obtain an edge computing frequency allocation constraint corresponding to each edge server;
performing constraint construction based on a preset task deadline of each industrial device, to obtain a task deadline constraint corresponding to each industrial device; and
performing constraint construction based on a trust score and a preset threshold that are of a completed task amount corresponding to each edge server, to obtain a trustworthiness constraint corresponding to each edge server.

3. The method according to claim 1, wherein before the performing model construction on the basis of preset constraints respectively corresponding to a task and resource joint scheduling stage of the industrial wireless network and a consensus stage of the dynamic blockchain mechanism with maximizing task trustworthy processing efficiency as a target, the method further comprises:
constructing a function based on a preset trustworthiness verification delay function, a preset task transmission delay function and a preset edge computing delay function to obtain a trustworthy computing process function;
constructing a function based on the trustworthy computing process function, a preset transaction record report delay function, a preset allowed maximum consensus waiting delay function and a preset practical maximum consensus waiting delay function to obtain an actual consensus waiting delay function;
constructing a function based on the actual consensus waiting delay function and the preset block generation delay function to obtain an edge trustworthy computing delay function;
constructing a function based on the edge trustworthy computing delay function and the local computing delay function corresponding to each of the industrial devices to obtain a task trustworthy computing delay function corresponding to each of the industrial devices; and
constructing a function based on the task trustworthy computing delay function corresponding to the same industrial device and the task size to obtain the trustworthy processing efficiency function corresponding to the same industrial device.

4. The method according to claim 1, wherein before performing model reconstruction on the optimization model based on a preset multi-agent Markov decision process model, the method further comprises: constructing a preset multi-agent Markov decision process model comprising:
constructing an agent set, an observation set, and an action set of the preset multi-agent Markov decision process model;
constructing a function based on a preset trustworthy computing reward function, a preset timeout penalty function, and a preset consensus penalty function to obtain a reward function of the preset multi-agent Markov decision process model; and
constructing a model based on the agent set, the observation set, the action set, and the reward function to obtain the preset multi-agent Markov decision process model.

5. The method according to claim 2, wherein before optimizing the target optimization model using a preset rotating multi-agent deep reinforcement learning algorithm model on the basis of observation information of industrial devices in the industrial wireless network collected in real time, the method further comprises: constructing a preset rotating multi-agent deep reinforcement learning algorithm model comprising:
constructing an initial model corresponding to each edge server, the initial model comprising an initial actor neural network, two initial critic neural networks and two initial target critic neural networks;
initializing the initial model corresponding to the preset initial leader edge server in each edge server to obtain the initial model parameters corresponding to the initial leader edge server; and
training the initial model based on historical experience data, initial model parameter, a preset first loss function, a preset second loss function, a preset third loss function, and a preset entropy regularization loss function to obtain the target deep reinforcement learning model corresponding to each edge server, so as to obtain the preset rotating multi-agent deep reinforcement learning algorithm, wherein the target deep reinforcement learning model comprises: a target actor neural network, two critic neural networks and two target critic neural networks corresponding to each critic neural network for stabilizing the critic neural networks.

6. The method according to claim 5, wherein the training the initial model based on historical experience data, initial model parameter, a preset first loss function, a preset second loss function, a preset third loss function, and a preset entropy regularization loss function to obtain the target deep reinforcement learning model corresponding to each edge server comprises:
performing a leader election in the first time slot based on the initial edge computing frequency, initial trust score and initial channel state of each edge server, to obtain an initial leader edge server;
training the initial model corresponding to the initial leader edge server based on a preset first loss function, a preset second loss function, a preset third loss function, and a preset entropy regularization loss function to obtain a current first model corresponding to the initial leader edge server;
sending the model parameters of the current first model to each first edge server that is not the initial leader edge server, updating the initial model corresponding to each first edge server based on the model parameters, and obtaining the current first model corresponding to each first edge server, wherein the model parameters include the first model parameter, the second model parameter, the third model parameter and the first entropy regularization coefficient corresponding to the initial leader edge server; and
in a non-first time slot, re-electing a leader based on the current edge computing frequency, current trust scores and current channel status of each edge server to obtain a current leader edge server; training a current first model corresponding to the current leader edge server based on a preset first loss function, a preset second loss function, a preset third loss function and a preset entropy regularization loss function to update the current first model; sending the updated model parameters of the current first model to each second edge server that is not the current leader edge server, updating the current first model corresponding to each second edge server based on the model parameters, iterating repeatedly until the algorithm converges, and training to obtain the preset rotating multi-agent deep reinforcement learning algorithm model.

7. The method according to claim 6, wherein the optimizing the target optimization model using a preset rotating multi-agent deep reinforcement learning algorithm model on the basis of observation information of industrial devices in the industrial wireless network collected in real time, to obtain target parameters corresponding to the parameters to be optimized for scheduling the industrial wireless network comprises:
performing action prediction using the target actor neural network in the preset rotating multi-agent deep reinforcement learning algorithm model based on the observation information of each industrial device in the industrial wireless network collected in real time, to obtain the target parameters corresponding to parameters to be optimized for scheduling the industrial wireless network, wherein the parameters to be optimized comprises: a task division proportion, a bandwidth allocation proportion, an edge computing frequency for task processing and block generation, a dynamic waiting time window in the blockchain, and a leader edge server elected by the edge servers.

8. A dynamic blockchain-based trustworthy scheduling device for an industrial wireless network, comprising:
an industrial wireless network construction module configured to construct an industrial wireless network based on a dynamic blockchain mechanism;
a model construction module configured to perform model construction on the basis of preset constraints respectively corresponding to a task and resource joint scheduling stage of the industrial wireless network and a consensus stage of the dynamic blockchain mechanism with maximizing task trustworthy processing efficiency as a target, to obtain an optimization model for scheduling the industrial wireless network, the optimization model carrying parameters to be optimized;
a model reconstruction module configured to perform model reconstruction on the optimization model based on a preset multi-agent Markov decision process model to obtain a target optimization model; and
an optimization module configured to optimize the target optimization model using a preset rotating multi-agent deep reinforcement learning algorithm model on the basis of observation information of industrial devices in the industrial wireless network collected in real time, to obtain target parameters corresponding to the parameters to be optimized for scheduling the industrial wireless network.

9. A storage medium, wherein the storage medium stores a computer program, and when the computer program is executed by a processor, the steps of the method according to claim 1 are implemented.

10. An electronic device, comprising:
at least a memory and a processor, and the memory stores a computer program, and when the processor executes the computer program on the memory, the steps of the method according to claim 1 are implemented.
